(19) United States
(12) Patent Application Publication
(10) Pub. No.: US 2006/0044184 A1
(43) Pub. Date: Mar. 2, 2006

(54) Positioning system, terminal apparatus, control program for terminal apparatus, and computer readable recording medium having recorded therein control program for terminal apparatus

(75) Inventor: Akira Kimura, Shiojiri-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/214,776

(22) Filed: Aug. 31, 2005

(30) Foreign Application Priority Data
Sep. 2, 2004 (JP) JP2004-255281

(51) Int. Cl. G01S 5/14

(52) U.S. Cl. 342/357.09; 342/357.15

(57) ABSTRACT

A positioning system including a terminal apparatus that acquires positioning positional information from a positioning apparatus that performs positioning calculations based on position related signals from a plurality of positional information satellites, and a supplementary information providing apparatus that is capable of communicating with the terminal apparatus and provides the terminal apparatus with supplementary information for receiving the position related signals, wherein the supplementary information includes Doppler frequency information is provided. The positioning system is configured to acquire information indicating drift even if the positioning system is a server positioning type positioning system.

### CROSS-REFERENCE TO RELATED APPLICATIONS

This application claims priority to Japanese Patent Application No. 2004-255281. The entire disclosure of Japanese Patent Application No. 2004-255281 is hereby incorporated herein by reference.

### BACKGROUND OF THE INVENTION

1. Field of the Invention

The present invention generally relates to a positioning system. More specifically, the present invention relates to a positioning system, a terminal apparatus, a control program for the terminal apparatus, and a computer readable recording medium having recorded therein the control program for the terminal apparatus that are based on position related signals from positional information satellites.

2. Background Information

A positioning system, which utilizes a satellite navigation system using a positional information satellite, for example, a Global or Satellite Positioning System (SPS) to determine a position of an SPS receiver, has been put to practical use. In such a positioning system, there is a system in which an SPS receiver acquires, from an outside assist server, assist data for receiving a satellite signal from an SPS satellite, uses the assist data to generate information forming a basis of positioning calculation on the basis of the received satellite signal (hereinafter referred to as positioning basis information), transmits the positioning basis information to a positioning server on the outside, and receives a positioning result performed by the positioning server (hereinafter referred to as a server positioning type). Such a system is shown in Japanese Patent Publication NO. JP-A-2000-131415 (FIG. 1, etc.), which is hereby incorporated by refernce.

In such a server positioning type positioning system, it is unnecessary to perform the positioning calculations inside the SPS receiver. Thus, there is an advantage in that it is easy to design a terminal and it is possible to reduce production costs.

In the SPS receiver, in order to generate a frequency forming a basis for generating a synchronizing frequency, oscillating means, for example, a quartz oscillator is used in the SPS receiver. An oscillation frequency of this quartz oscillator changes because of temperature to cause a shift in a reception frequency for receiving a satellite signal (hereinafter referred to as drift). However, in the server positioning type positioning system, there is a problem in that the drift is not fed back and a long time is required to receive a satellite signal from the SPS satellite in some cases.

In view of the above, it will be apparent to those skilled in the art from this disclosure that there exists a need for an improved a positioning system, a terminal apparatus, a control program for the terminal apparatus, and a computer readable recording medium having recorded therein the control program for the terminal apparatus that are based on position related signals from positional information satellites. This invention addresses this need in the art as well as other needs, which will become apparent to those skilled in the art from this disclosure.

### SUMMARY OF THE INVENTION

Therefore, an object of the present invention is to provide a positioning system, a terminal apparatus, a control program for the terminal apparatus, and a computer readable recording medium having recorded therein the control program for the terminal apparatus that can acquire information indicating drift even if the positioning system is a server positioning type positioning system.

According to a first aspect of present invention, a positioning system is provided having a terminal apparatus and a supplementary information providing apparatus. The terminal apparatus acquires positioning positional information from a positioning apparatus that performs positioning calculation based on position related signals from a plurality of positional information satellites. The supplementary information providing apparatus is capable of communicating with the terminal apparatus and provides the terminal apparatus with supplementary information to receive the position related signals. In the positioning system, the supplementary information includes Doppler frequency information indicating a Doppler frequency that reflects a change in a frequency of the position related signals due to relative movement of the respective positional information satellites and the terminal apparatus. The terminal apparatus includes a supplementary information acquiring unit, a signed receiving unit, a reception frequency information generating unit, a frequency difference information generation unit, a drift frequency information generating unit, a positioning-requiring-number-of-position-related signals receiving unit, a positioning basis information generating unit, and a positioning basis information transmitting unit. The supplementary information acquiring unit acquires the supplementary information from the supplementary information providing apparatus. The signal receiving unit receives the position related signals from the positional information satellites on the basis of the supplementary information. The reception frequency information generating unit generates reception frequency information indicating a reception frequency at the time when the position related signals are received. The frequency difference information generating unit generates frequency difference information indicating a frequency difference between a transmission frequency, which is a frequency at the time when the respective positional information satellites transmit the position related signals, and the reception frequency. The drift frequency information generating unit generates drift frequency information indicating a drift frequency, which is shift of the reception frequency due to a factor inside the terminal apparatus, on the basis of the Doppler frequency information included in the supplementary information and the frequency difference information generated by the terminal apparatus. The positioning-requiring-number-of-position-related-signals receiving unit receives as many position related signals as required for positioning calculations by the positioning apparatus on the basis of the transmission frequency information indicating the transmission frequency of the position related signals from the respective positional information satellites, the Doppler frequency information corresponding to the respective positional information satellites, and the drift frequency information. The positioning basis information generating unit generates positioning basis information to be used by the positioning apparatus for the positioning calculations on the basis of the received respective position related signals. The positioning basis information transmitting unit transmits the positioning basis information to the positioning apparatus.

In order to receive the position related signals from the positional information satellites, the terminal apparatus is required to synchronize with the position related signals taking into account not only a frequency at the time when the position related signals are transmitted from the respective positional information satellites (hereinafter referred to as transmission frequency) but also a change in a frequency due to the Doppler effect (hereinafter referred to as Doppler frequency) caused by relative positional movement of the respective positional information satellites and the terminal apparatus and a change in a frequency due to a factor inside the terminal apparatus.

The change in a frequency due to a factor inside the terminal apparatus is, for example, a shift of a frequency to receive the position related signals (the drift described above) that is caused by a change in an oscillation frequency due to the temperature of the quartz oscillator to generate a frequency forming a basis of a synchronizing frequency of the terminal apparatus.

The supplementary information providing apparatus can calculate the Doppler frequency on the basis of a general position of the terminal apparatus and orbit information of the respective positional information satellites and provide the terminal apparatus with the Doppler frequency. On the other hand, since the drift varies depending on the terminal apparatus, the supplementary information providing apparatus, which is an external apparatus, cannot calculate the drift.

Therefore, in order to synchronize with the position related signals, the terminal apparatus itself needs to generate information indicating the drift. This is because if there is no information indicating the drift and since the terminal apparatus searches for the position related signals on the basis of only the transmission frequency and the Doppler frequency, a long time may be required for reception of the position related signals.

In this respect, according to the first aspect of the invention, the terminal apparatus can generate frequency difference information indicating a frequency difference between the transmission frequency and the reception frequency with the frequency difference information generating unit.

This frequency difference information includes both the Doppler frequency and the drift. Therefore, it is possible to calculate the drift if the Doppler frequency is excluded from a frequency indicated by the frequency difference information. In other words, the terminal apparatus can generate drift frequency information, which indicates a drift frequency that is a reception frequency shift due to a factor inside the terminal apparatus, with the drift frequency information generating unit on the basis of the Doppler frequency information included in the supplementary information and the frequency difference information generated by the terminal apparatus.

Besides, since positioning calculations are not performed in order to generate the drift frequency information, it is possible to generate promptly the drift frequency information compared with a case in which positioning calculations are performed. Consequently, it is possible to provide a positioning system that can acquire information indicating drift even if the positioning system is a server positioning type positioning system.

Moreover, the terminal apparatus can receive as many position related signals as necessary for positioning calculations by the positioning apparatus with the positioning-requiring-number-of-position-related-signals receiving unit on the basis of the transmission frequency information indicating the transmission frequency, the Doppler frequency information corresponding to the respective positional information satellites, and the drift frequency information. Consequently, after generating the drift frequency information, it is possible to receive as many position related signals as required for positioning calculations by the positioning apparatus.

According to a second aspect of the present invention, the above mentioned object is realized by a terminal apparatus that acquires positioning positional information from a positioning apparatus that performs positioning calculations based on position related signals from a plurality of positional information satellites. The terminal apparatus includes a supplementary information acquiring unit, a signal receiving unit, a reception frequency information generating unit, a frequency difference information generating unit, a drift frequency information generating unit, a positioning-requiring-number-of-position-related-signals receiving unit, and a positioning basis information transmitting unit. The supplementary information acquiring unit acquires supplementary information, which includes Doppler frequency information indicating a Doppler frequency that reflects a change in a frequency of the position related signals due to relative movement of the respective positional information satellites and the terminal apparatus, from a supplementary information providing apparatus capable of communicating with the terminal apparatus. The signal receiving unit receives the position related signals from the positional information satellites on the basis of the supplementary information. The reception frequency information generating unit generates reception frequency information indicating a reception frequency at the time when the position related signals are received. The frequency difference information generating unit generates frequency difference information indicating a frequency difference between a transmission frequency, which is a frequency at the time when the respective positional information satellites transmit the position related signals, and the reception frequency. The drift frequency information generating unit generates drift frequency information indicating a drift frequency, which is a reception frequency shift due to a factor inside the terminal apparatus, on the basis of the Doppler frequency information included in the supplementary information and the frequency difference information generated by the terminal apparatus. The positioning-requiring-number-of-position-related-signals receiving unit receives as many position related signals as required for positioning calculations by the positioning apparatus on the basis of the transmission frequency information indicating the transmission frequency of the position related signals from the respective positional information satellites, the Doppler frequency information corresponding to the respective positional information satellites, and the drift frequency information. The positioning basis information generating unit generates positioning basis information to be used by the positioning apparatus for the positioning calculations on the basis of the received respective position related signals. The positioning basis information transmitting unit transmits the positioning basis information to the positioning apparatus.

The configuration of the second aspect of the present invention, as in the first aspect of the invention, provides that the terminal apparatus can acquire information indicating drift even if the positioning system is a server positioning type positioning system.

A positioning system according to a third aspect of the present invention, is the system of the second aspect of the invention wherein, the drift frequency information generating unit generates the drift frequency information on the basis of at least one set of the Doppler frequency information and the frequency difference information.

According to system of the third aspect of the present invention, for example, it is possible to generate promptly the drift frequency information by generating the drift frequency information on the basis of one set of the Doppler frequency information and the frequency difference information. In addition, for example, by generating the drift frequency information on the basis of three sets of the Doppler frequency information and the frequency difference information, it is possible to generate drift frequency information that is more accurate than that in the case in which one set of the Doppler frequency information and the frequency difference information is used.

A positioning system according to a fourth aspect of the present invention is the system of the second or the third aspect of the invention in which the terminal apparatus includes a preliminary-positioning-positioned-information generating unit and a preliminary-positioning-positioned-information-with-minimun-error sending unit. The preliminary-positioning-positional-information generating unit performs preliminary positioning calculations on the basis of the plurality of position related signals received by the signal receiving unit to generate preliminary positioning positional information indicating a preliminary positioning position. The preliminary-positioning-positional-information-with-minimum-error selecting unit selects preliminary positioning positional information with minimum error that is the preliminary positioning positional information with a minimum positioning error from a plurality of pieces of the preliminary positioning positional information generated by the preliminary-positioning-positional-information generating unit. The reception frequency information generating unit generates the reception frequency information indicating a frequency at which the position related signals corresponding to the preliminary positioning positional information with minimum error are received.

When a signal received by the terminal apparatus is a signal from a satellite other than the positional information satellite, when a signal from the positional information satellite reflects on a building to reach the terminal apparatus, and the like (the signals are hereinafter referred to error signals), the terminal apparatus cannot generate accurate drift frequency information. In this regard, according to the configuration of the fourth aspect of the invention, the terminal apparatus can generate the preliminary positioning positional information with the preliminary-positioning-positional-information generating unit. Unlike the positioning positional information generated by the positioning apparatus, this preliminary positioning positional information is information that is generated by positioning calculations of a preliminary nature carried out inside the terminal apparatus. Whereas the positioning positional information generated by the positioning apparatus may be generated through a complicated arithmetic operation such as map matching, the preliminary positioning positional information only has to attain an object of excluding the error signal. Thus, the positioning calculation is a provisional positioning calculation based on limited information held by the terminal apparatus. Therefore, the terminal apparatus can more promptly generate the preliminary positioning positional information compared with the case in which a complicated arithmetic operation is performed.

With regards to excluding error signals, signals that are apparently different from default values are considered to be errors. More specifically, if a received signal is different from what is expected by a predetermined amount, the received signal is considered to be unrelated to the GPS or a reflecting wave and is excluded.

The terminal apparatus can select the preliminary position information with minimum error from the plurality pieces of preliminary positioning positional information with the preliminary-positioning-positional-information-with-minimum-error selecting unit. Since the preliminary positioning positional information generated on the basis of the error signal has a large error, the preliminary positioning positional information is excluded by the preliminary-positioning-positional-information-with-minimum-error selecting unit.

Moreover, the reception frequency information generating unit of the terminal apparatus generates the reception frequency information indicating a frequency at which the position related signals corresponding to the preliminary positional information with minimum error are received. Consequently, the terminal apparatus can exclude an error signal and the like as a prerequisite to generate the drift frequency information. Thus, it is possible to generate the accurate drift frequency information.

A positioning system according to a fifth aspect of the present invention is the system of any one of the second to the fourth aspects of the present invention, wherein the terminal apparatus includes a drift information storing unit that stores the drift frequency information, and the signal receiving unit uses the drift frequency information in order to receive the position related signals to acquire the positioning positional information from the positioning apparatus for the next time period.

According to the configuration of the fifth aspect of the present invention, the terminal apparatus can not only use the drift frequency information in order to acquire the positioning positional information once, but also use the drift frequency information in acquiring the positioning positional information for the next time period.

A positioning system according to a sixth aspect of the present invention is the system of any one of the second to the fifth aspects of the invention, wherein the terminal apparatus includes a drift-frequency-transition-information-storing unit, a temperature-information-at-drift-information-generation-time generating unit, and a drift-frequency-transition-information correcting unit. The drift-frequency-transition-information storing unit stores drift frequency transition information indicating transition of the drift frequency due to temperature change. The temperature-information-at-drift-information-generation-time generating unit generates temperature information at the time of drift information generation indicating temperature at the time when the drift frequency information is generated. The drift-frequency-transition-information correcting unit corrects the drift frequency transition information on the basis of the drift frequency information and the temperature information at the time of drift information generation.

According to the configuration in the sixth aspect of the invention, the terminal apparatus stores the drift frequency transition information in the drift-frequency-transition-information storing unit. In other words, the terminal apparatus has data a change in drift of the terminal apparatus due to temperature. The terminal apparatus can promptly receive the position related signal by using the drift frequency transition information. However, a characteristic of, for example, a quartz oscillator, which generates a frequency forming a basis of a synchronizing frequency of the terminal apparatus, changes with time and the drift frequency transition information stored by the terminal apparatus diverges from an actual state in some cases.

In this respect, since the terminal apparatus has the drift-frequency-transition-information correcting unit, the terminal apparatus can correct the drift frequency transition information on the basis of the drift frequency information and the temperature information at the time of drift information generation.

According to a seventh aspect of the present invention, the above mentioned object is realized by a control program for a terminal apparatus that causes a computer to execute a supplementary information acquiring step, a signal receiving step, a reception frequency information generating step, a frequency difference information generating step, a drift frequency information generating step, a positioning-requiring-number-of-position-related-signals receiving step, a positioning basis information generating step, and a positioning basis information transmitting step. In the supplementary information acquiring step, a terminal apparatus that acquires positioning positional information from a positioning apparatus that performs positioning calculations based on position related signals from a plurality of positional information satellites acquires supplementary information from a supplementary information providing apparatus that is capable of communicating with the terminal apparatus. The supplementary information includes Doppler frequency information indicating a Doppler frequency that reflects a change in a frequency of the position related signals due to relative movement of the respective positional information satellites and the terminal apparatus. In the signal receiving step, the terminal apparatus receives the position related signals from the positional information satellites on the basis of the supplementary information. In the reception frequency information generating step, the terminal apparatus generates reception frequency information indicating a reception frequency at the time when the position related signals are received. In the frequency difference information generating step, the terminal apparatus generates frequency difference information indicating a frequency difference between the transmission frequency and the reception frequency. In the drift frequency information generating step, the terminal apparatus generates drift frequency information indicating a drift frequency, which is shift of the reception frequency due to a factor inside the terminal apparatus, on the basis of the Doppler frequency information included in the supplementary information and the frequency difference information generated by the terminal apparatus. In the positioning-requiring-number-of-position-related-signals receiving step, the terminal apparatus receives as many position related signals as required for positioning calculations by the positioning apparatus on the basis of the transmission frequency information indicating the transmission frequency of the position related signals from the respective positional information satellites, the Doppler frequency information corresponding to the respective positional information satellites, and the drift frequency information. In the positioning basis information generating step, the terminal apparatus generates positioning basis information to be used by the positioning apparatus for the positioning calculation on the basis of the received respective position related signals. In the positioning basis information transmitting step, the terminal apparatus transmits the positioning basis information to the positioning apparatus.

According to an eighth aspect of the invention, the above mentioned object is realized by a computer recording medium having recorded therein a control program for a terminal apparatus. The control program causes a computer to execute a supplementary information acquiring step, a signal receiving step, a reception frequency information generating step, a frequency difference information generating step, a drift frequency information generating step, a positioning-requiring-number-of-position-related-signals receiving step, a positioning basis information generating step, and a positioning basis information transmitting step. In the supplementary information acquiring step, a terminal apparatus, which acquires positioning positional information from a positioning apparatus that performs positioning calculations based on position related signals from a plurality of positional information satellites, acquires supplementary information. The supplementary information includes Doppler frequency information indicating a Doppler frequency that reflects a change in a frequency of the position related signals due to relative movement of the respective positional information satellites and the terminal apparatus from a supplementary information providing apparatus that is capable of communicating with the terminal apparatus. In the signal receiving step, the terminal apparatus receives the position related signals from the positional information satellites on the basis of the supplementary information. In the reception frequency information generating step, the terminal apparatus generates reception frequency information indicating a reception frequency at the time when the position related signals are received. In the frequency difference information generating step, the terminal apparatus generates frequency difference information indicating a frequency difference between the transmission frequency and the reception frequency. In the drift frequency information generating step, the terminal apparatus generates drift frequency information indicating a drift frequency, which is shift of the reception frequency due to a factor inside the terminal apparatus, on the basis of the Doppler frequency information included in the supplementary information and the frequency difference information generated by the terminal apparatus. In the positioning-requiring-number-of-position-related-signals receiving step, the terminal apparatus receives as many position related signals as required for positioning calculations by the positioning apparatus on the basis of the transmission frequency information indicating the transmission frequency of the position related signals from the respective positional information satellites, the Doppler frequency information corresponding to the respective positional information satellites, and the drift frequency information. In the positioning basis information generating step, the terminal apparatus generates positioning basis information to be used by the positioning apparatus for the positioning calculations on the basis of the received respective position related signals. In the positioning basis information transmitting step, the terminal apparatus transmits the positioning basis information to the positioning apparatus.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a view of a schematic diagram showing a positioning system in accordance with first and second preferred embodiments of the present invention;

FIG. 2 is a view of a schematic diagram showing a main hardware configuration of an assist server of the positioning system;

FIG. 3 is a view of a schematic diagram showing a main hardware configuration of a terminal of the positioning system of the first embodiment;

FIG. 4 is a view of a schematic diagram showing a main software configuration of the assist server;

FIG. 5 is a view of a schematic diagram showing a main software configuration of the terminal;

FIG. 6 is a view of a diagram showing a transmission frequency and the like from an SPS satellite of the positioning system;

FIGS. 7A and 7B are views of diagrams showing an example of transmission/reception frequency difference information and the like of the positioning system;

FIG. 8 is a view of a diagram showing an example of positioning basis information of the positioning system;

FIG. 9 is a view of a schematic flowchart showing an example of an operation of the positioning system;

FIG. 10 is a view of a schematic diagram showing a main software configuration of a terminal in the positioning system of the second embodiment;

FIG. 11 is a view of a graph showing an example of drift transition estimation model information in the positioning system of the second embodiment;

FIG. 12 is a view of a graph showing an example of a drift transition estimation model correction program in the positioning system of the second embodiment; and

FIG. 13 is a view of a schematic flowchart showing an example of an operation of the positioning system of the second embodiment.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Note that since embodiments to be described below are preferred specific examples of the invention, technically preferable various limitations are attached to the embodiments. However, the scope of the invention is not limited to these modes unless there are descriptions specifically limiting the invention in the following explanation.

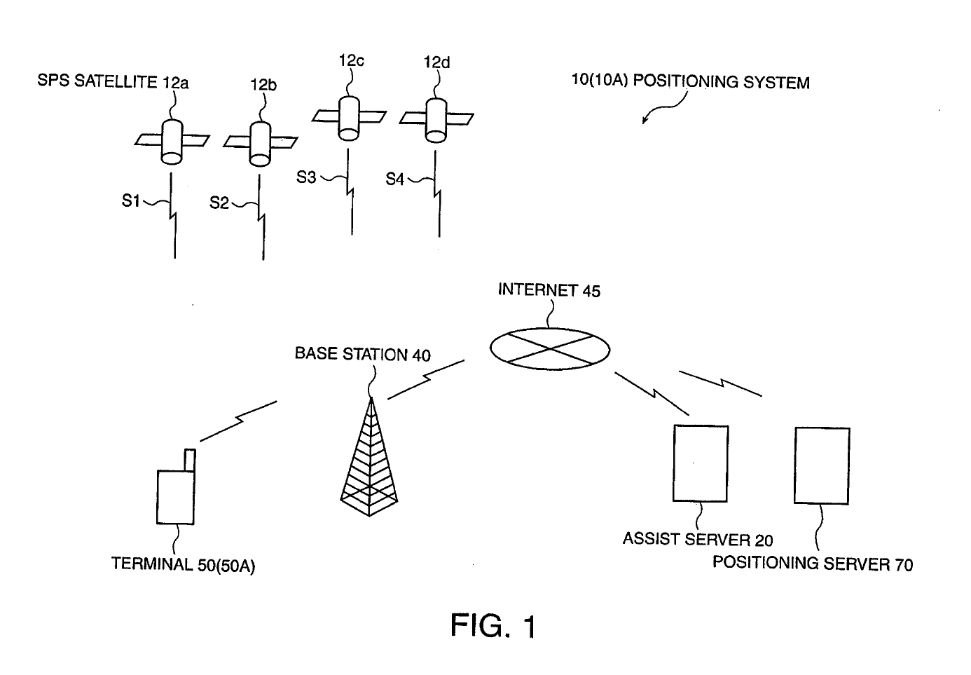

FIG. 1 is a view of a schematic diagram showing a positioning system 10 according to preferred embodiments of the present invention. As shown in FIG. 1, the positioning system 10 includes a positioning apparatus, for example, a positioning server 70 that performs positioning calculations based on position related signals, for example, signals S1, S2, S3, and S4 from a plurality of positional information satellites, for example, SPS satellites 12a, 12b, 12c, and 12d. The positioning system 10 also includes a terminal apparatus, for example, a terminal apparatus 50 that acquires positioning positional information from the positioning server 70. The positioning system 10 also includes a supplementary information providing apparatus, for example, an assist server 20 that provides the terminal 50 with supplementary information, for example, assist data described later to receive the signals S1-S4.

The terminal 50 is capable of communicating with the positioning server 70 and the assist server 20 via a communication base station, for example, a base station 40 and a communication network, for example, the Internet 45. The terminal 50 is, for example, a cellular phone but may be a PHS (Personal Handy-phone System), a PDA (Personal Digital Assistant), or the like. Note that the assist server 20 and the positioning server 70 may be formed as a single apparatus.

Main Hardware Configuration of the Assist Server 20

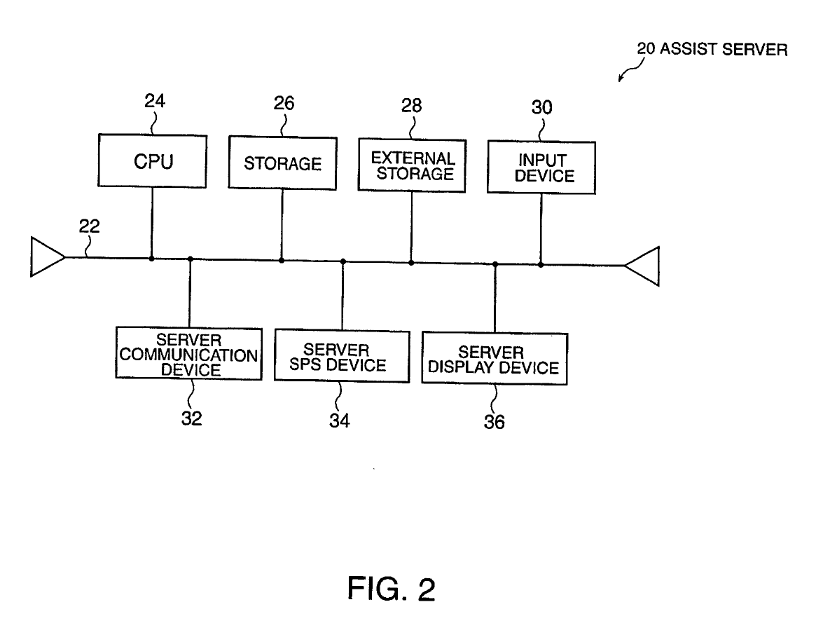

FIG. 2 is a view of schematic diagram showing a main hardware configuration of the assist server 20. As shown in FIG. 2, the assist server 20 includes, for example, a computer. The computer includes a bus 22, and a Central Processing Unit (CPU) 24, a storage 26, an external storage 28, and the like connected to the bus 22. The CPU 24 is a control unit that performs processing of a predetermined program and controls the storage 26 and the like connected to the bus 22. The storage 26 is, for example, a Random Access Memory (RAM) or a Read Only Memory (ROM). The external storage 28 is, for example, a Hard Disk (HD).

An input device 30 provided to input various kinds of information and a server communication device 32 provided to communicate with the terminal 50 are also connected to the bus 22. A server SPS device 34 is also connected to the bus 22. Consequently, the assist server 20 is capable of receiving the signals S1-S4 from the SPS satellites 12a-12d (see FIG. 1), and acquiring satellite information including orbit information and the like of the SPS satellites 12a-12d. Further, a server display device 36 to display the various kinds of information is also connected to the bus 22.

Main Hardware Configuration of the Terminal 50

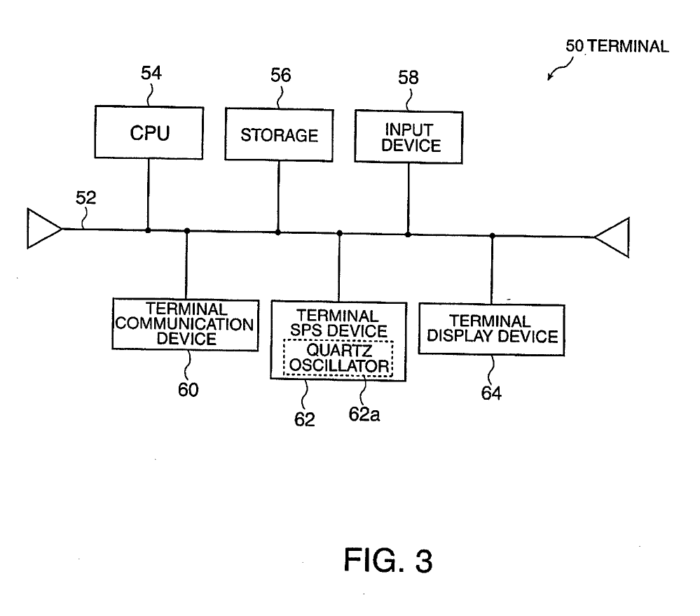

FIG. 3 is a view of a schematic diagram showing a main hardware configuration of the terminal 50. As shown in FIG. 3, the main hardware configuration of the terminal 50 is similar to the main hardware configuration of the assist server 20. However, the terminal 50 does not include an external storage.

A terminal SPS device 62 is an example of a signal receiving unit that receives the signals S1 to S4 from the SPS satellites 12a-12d (see FIG. 1) on the basis of assist data described later that are acquired from the assist server 20. As shown in FIG. 3, the terminal SPS device 62 includes a quartz oscillator 62a. The quartz oscillator 62a is a device that generates a signal forming a basis of a synchronizing signal that is necessary for the terminal SPS device 62 to acquire the signals S1-S4 from the SPS satellites 12a-12d. An oscillation frequency of the quartz oscillator 62a changes according to temperature. A change in a reception frequency of the signals S1-S4 caused by a change in the oscillation frequency of the quartz oscillator 62a due to temperature is referred to as drift.

Main Software Configuration of the Assist Server 20

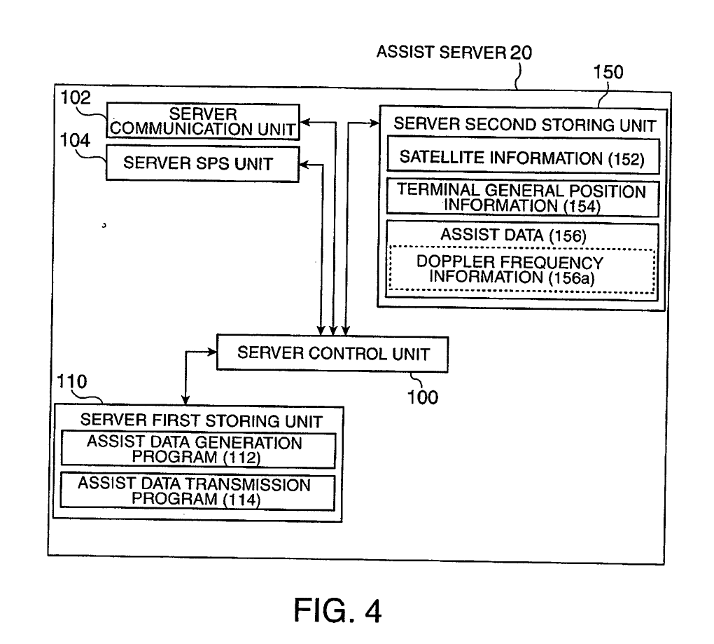

FIG. 4 is a view of a schematic diagram showing a main software configuration of the assist server 20. As shown in FIG. 4, the assist server 20 includes a server control unit 100 that controls respective units, a server communication unit 102 corresponding to the server communication device 32 (see FIG. 2), a server SPS unit 104 corresponding to the server SPS device 34 (see FIG. 2), and the like. As shown in FIG. 4, the assist server 20 also includes a server first storing unit 110 that stores various programs, and a server second storing unit 150 that stores various kinds of information.

The assist server 20 stores an assist data generation program 112 in the server first storing unit 110. The assist data generation program 112 has information to allow the server control unit 100 to generate assist data 156 on the basis of a request from the terminal 50. The assist data 156 are an example of supplementary information.

Specifically, the server control unit 100 generates the assist data 156 according to the assist data generation program 112 on the basis of satellite information 152, which is acquired and stored in the server second storing unit 150 in advance, and terminal general position information 154 indicating a general position of the terminal 50. The satellite information 152 includes orbit information and the like of the SPS satellites 12a-12d (see FIG. 1). The terminal general position information 154 is information indicating a position of a base station 40 (see FIG. 1) to which the terminal connects. The server control unit 100 stores the generated assist data 156 in the server second storing unit 150.

The assist data 156 are, for example, information including identification codes of the SPS satellites 12a-12d, which the terminal 50 can observe, and elevation angles of the respective SPS satellites 12a-12d. In addition, as shown in FIG. 4, Doppler frequency information 156a is included in the assist data 156. The Doppler frequency information 156a is information indicating a Doppler frequency that reflects a change in a frequency of the signals S1-S4 due to a relative movement of the respective SPS satellites 12a- 12d and the terminal 50. In other words, the Doppler frequency information 156a is an example of Doppler frequency information.

The server control unit 100 can calculate a Doppler frequency of each of the SPS satellites 12a-12d included in the satellite information 152 on the basis of orbit information of the respective SPS satellite 12a-12d included in the satellite information 152. The server control unit 100 can also calculate a general position of the terminal 50 indicated by the terminal general position information 154 and calculate Doppler frequency information 156a.

As shown in FIG. 4, the assist server 20 stores an assist data transmission program 114 in the server first storing unit 110. The assist data transmission program 114 has information to allow the server control unit 100 to transmit the assist data 156 to the terminal 50.

Main Software Configuration of the Terminal 50

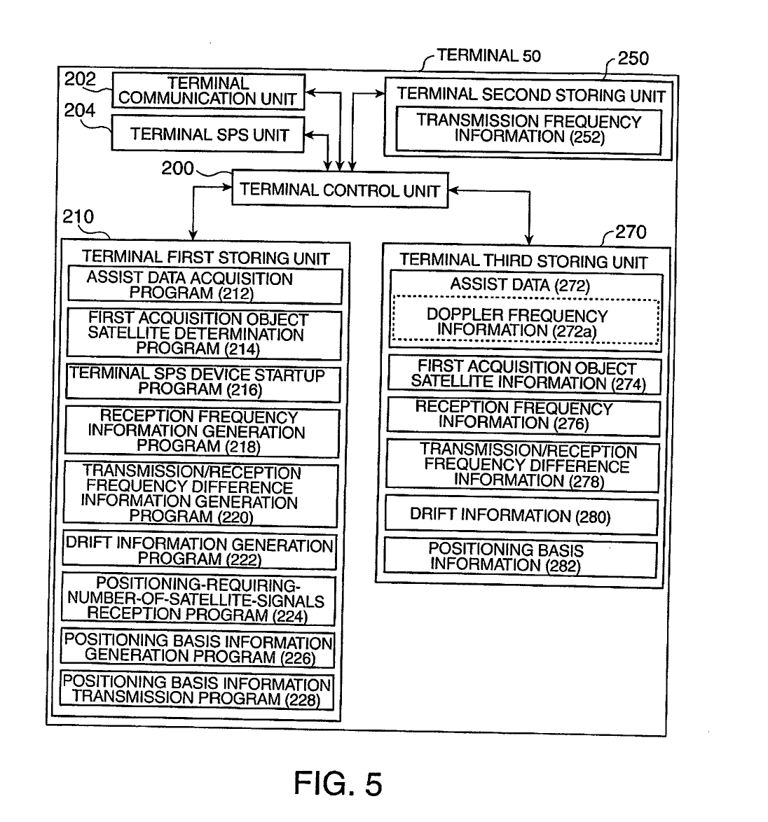

FIG. 5 is a schematic diagram showing a main software configuration of the terminal 50. As shown in FIG. 5, the terminal 50 includes a terminal control unit 200 that controls respective units, a terminal communication unit 202 corresponding to the terminal communication device 60 (see FIG. 3), and a terminal SPS unit 204 corresponding to the terminal SPS device 62 (see FIG. 3) and the like. As shown in FIG. 5, the terminal 50 also includes a terminal first storing unit 210 that stores various programs, a terminal second unit 250 that stores various kinds of information in advance, and a terminal third storing unit 270 that stores information acquired or generated by the terminal 50.

The terminal 50 stores an assist data acquisition program 212 in the terminal first storing unit 210. The assist data acquisition program 212 has information that allows the terminal control unit 200 to request assist data from the assist server 20, and to acquire the assist data 156 (see FIG. 4). In other words, the assist data acquisition program 212 and the terminal control unit 200 are examples of the supplementary information acquiring unit. Further, the terminal control unit 200 stores the assist data 156 acquired from the assist server 20 in the terminal third storing unit 270 as assist data 272. Moreover, the assist data 272 include Doppler frequency information 272a.

As shown in FIG. 5, the terminal 50 stores a first acquisition object satellite determination program 214 in the terminal first control unit 210. The first acquisition object satellite determination program 214 has information that allows the terminal control unit 200 to determine an SPS satellite to be acquired first among the SPS satellites 12a-12d (see FIG. 1).

The terminal control 200 determines, for example, the SPS satellite, for example, 12a with the largest elevation angle indicated in the assist data 272 as a first acquisition object satellite on the basis of the first acquisition object satellite determination program 214, generates a first acquisition object satellite information 274 indicating the SPS satellite 12a, and stores the first acquisition object satellite information 274 in the terminal third storing unit 270.

As shown in FIG. 5, the terminal 50 stores a terminal SPS device startup program 216 in the terminal first storing unit 210. The terminal SPS device startup program 216 has information that allows the terminal control unit 200 to start the terminal SPS device 62 (see FIG. 3). As described above, the terminal SPS device 62 is a device that receives the signals S1-S4 from the SPS satellites 12a-12d.

A signal frequency and the like, at which the terminal SPS device 62 receives the signals S1-S4, will be explained.

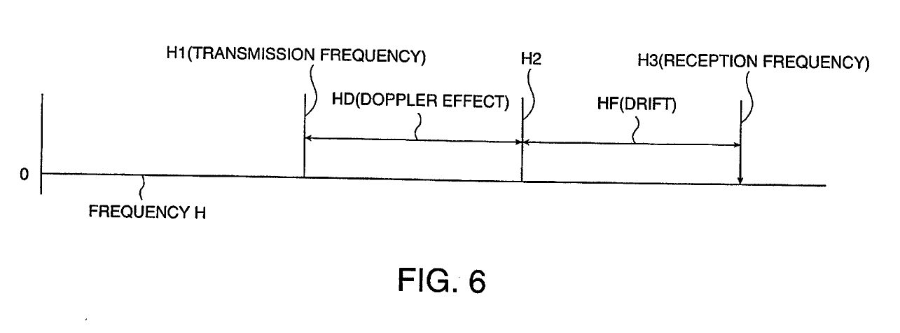

FIG. 6 is a view of a diagram showing a transmission frequency from the SPS satellite 12a. As shown in FIG. 6, for example, if the signal S1 is transmitted at a transmission frequency H1 from the SPS satellite, for example, 12a, first, the frequency H1 is displaced to H2 by the Doppler effect HD. A frequency of the signal S1 recognized by the terminal 50 is displaced to H3 by drift HF due to a change in an oscillation frequency of the quartz oscillator 62a (see FIG. 3) included in the terminal SPS device 62. This drift HF is a shift of a reception frequency of the signals S1-S4 due to a factor inside the terminal 50 and is an example of a drift frequency. Consequently, for the terminal 50, a signal with the frequency H3 is the signal S1.

Therefore, even if the terminal 50 acquires the assist data 272 including Doppler frequency information 272a indicating the Doppler effect HD from the assist server 20 and has information indicating the transmission frequency H1, when the terminal does not have information indicating the drift HF, the terminal 50 has to search for the signal S1 around the frequency H2. Thus, reception of the signal S1 may take a long time. In this regard, as explained below, the terminal 50 can acquire information indicating the drift HF without performing positioning. Thus, the terminal 50 can search for the signal S1 around the frequency H3 and promptly receive the signal S1.

Note that the terminal 50 extracts transmission frequency information 252, which indicates the transmission frequency H1 and the like of the signals S1-S4 from the SPS satellites 12a-12d, for example, from the assist data when the transmission frequency information 252 is included in the assist data 272. The terminal 50 stores the transmission frequency information 252 in the terminal second storing unit 250.

As shown in FIG. 5, the terminal 50 stores a reception frequency information generation program 218 in the terminal first storing unit 210. The reception frequency information generation program 218 has information that allows the terminal control unit 200 to generate reception frequency information 276 indicating a reception frequency at the time when the signals S1-S4 are received. In other words, the reception frequency information generation program 218 and the terminal control unit 200 are examples of the reception frequency information generating unit. The reception frequency information 276 is, for example, information indicating the frequency H3 (see FIG. 6) at which the signal S1 is received.

As shown in FIG. 5, the terminal 50 stores the transmission/reception frequency difference information generation program 220 in the terminal first storing unit 210. The transmission/reception frequency difference information generation program 220 has information that allows the terminal control unit 220 to generate, for example, a transmission/reception frequency difference information 278 indicating a frequency difference between the transmission frequency H1 (see FIG. 6) at the time when the SPS satellite 12a transmits the signal S1 and the reception frequency H3 (see FIG. 6) received by the terminal 50. This transmission/reception frequency difference information 278 is an example of the frequency difference information. The transmission/reception frequency difference information generation program 220 and the terminal control unit 200 are examples of the frequency difference information generating unit.

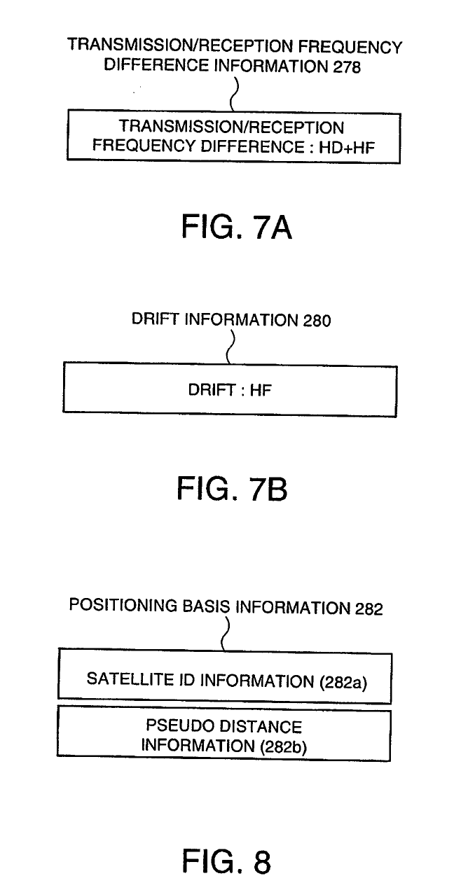

FIGS. 7A and 7B are views of diagrams showing examples of the transmission/reception frequency difference information 278 and drift information 280. The terminal control unit 200 generates, for example, the transmission/reception frequency difference information 278 (see FIG. 7A) indicating a frequency difference between the transmission frequency H1 and the reception frequency H3 on the basis of the transmission/reception frequency difference information generation program 220. The terminal control unit 200 stores the generated transmission/reception frequency difference information 278 in the terminal third storing unit 270.

As shown in FIG. 5, the terminal 50 stores a drift information generation program 222 in the terminal first storing unit 210. The drift information generation program 222 has information that allows the terminal control unit 200 to generate drift information 280 indicating a drift frequency on the basis of the Doppler frequency information 272a and the transmission/reception frequency difference information 278. This drift information 280 is an example of drift frequency information. The drift information generation program 222 and the terminal control unit 200 are examples of the drift frequency information generating unit.

In short, minimum positioning errors are decided by setting the nearest point to a previous surveying point. After detecting a satellite signal, more signals are detected to calculate the position. The nearest point is chosen from the points that are calculated by the detected signals.

As shown in FIG. 7A, the transmission/reception frequency difference information 278 includes the Doppler effect HD and the drift HF (see FIG. 6). Therefore, it is possible to generate the drift information 280 indicating the drift HF if the Doppler effect HD indicated by the Doppler frequency information 272a is excluded. Besides, since positioning calculations are not performed to generate the drift information 280, it is possible to generate promptly the drift information 280 compared with the case in which positioning calculations are performed.

The terminal control unit 200 generates the drift information 280 according to the drift information generation program 222 on the basis of at least one set of Doppler frequency information 272a and the transmission/reception frequency difference information 278. Consequently, for example, it is possible to generate promptly the drift information 280 by generating the drift information 280 on the basis of the one set of the Doppler frequency information 272a and the transmission/reception frequency difference information 278 corresponding to the SPS satellite 12a. For example, it is possible to generate drift information 280 that is more accurate than that in the case of one set of the Doppler frequency information 272a and the transmission/reception frequency difference information 278 by generating the drift information 280 on the basis of three sets of the Doppler frequency information 272a and the transmission/reception frequency difference information 278. Specifically, for example, it is possible to improve accuracy of the drift information 280 by adopting an average value of the three pieces of drift information 280 that are generated on the basis of the three pieces of the Doppler frequency information 272a and the transmission/reception frequency difference information 278.

The terminal control unit 200 stores the drift information 280 generated as described above in the terminal third storing unit 270. In other words, the terminal third storing unit 270 is an example of the drift information storing unit.

As shown in FIG. 5, the terminal 50 stores a positioning-requiring-number-of-satellite-signals reception program 224 in the terminal first storing unit 210. The positioning-requiring-number-of-satellite-signals reception program 224 has information that allows the terminal control unit 200 to receive as many signals S1-S4 from the SPS satellites 12a-12d as required for positioning calculations by the positioning server 70 (see FIG. 1) with the terminal SPS unit 204. The terminal control unit 200 receives the signals S1-S4 on the basis of the transmission frequency information 252 of the respective SPS satellites 12a-12d stored in the terminal second storing unit 250, the Doppler frequency information 272a corresponding to the respective SPS satellites 12a-12d, and the drift information 280. In other words, the positioning-requiring-number-of-satellite-signals reception program 224, the terminal control unit 200, and the SPS unit 204 are examples of the positioning-requiring-number-of-position-related-signals receiving unit. The number of the signals S1-S4 of the SPS satellites 12a-12d necessary for positioning calculations by the positioning server 70 in this embodiment is preferrably, for example, three in two-dimensional positioning and four in three-dimensional positioning.

As shown in FIG. 5, the terminal 50 stores a positioning basis information generation program 226 in the terminal first storing unit 210. The positioning basis information generation program 226 has information that allows the terminal control unit 200 to generate a positioning basis information 282, which the positioning server 70 (see FIG. 1) uses for positioning calculations, in response to the received signals S1-S4 (see FIG. 1). This positioning basis information 282 is an example of the positioning basis information. The positioning basis information generation program 226 and the terminal control unit 200 are examples of the positioning basis information generating unit.

FIG. 8 is a view of a diagram showing an example of the positioning basis information 282. As shown in FIG. 8, the positioning basis information 282 includes, for example, satellite ID information 282a to identify the SPS satellites 12a-12d and pseudo distance information 282b indicating a distance between the respective SPS satellites 12a-12d and the terminal 50. The terminal control unit 200 stores the generated positioning basis information 282 in the terminal third storing unit 270.

As shown in FIG. 5, the terminal 50 stores the positioning basis information transmission program 228 in the terminal first storing unit 210. The positioning basis information transmission program 228 has information that allows the terminal control unit 200 to transmit the positioning basis information 282 to the positioning server 70 (see FIG. 1). In other words, the positioning basis information transmission program 228 and the terminal control unit 200 are examples of the positioning basis information transmitting unit.

The terminal 50 can acquire positioning positional information, which the positioning server 70 generates through positioning calculation on the basis of the positioning basis information 282 from the positioning server 70. As described above, the terminal 50 can generate the transmission/reception frequency difference information 278 without performing positioning. The terminal 50 can generate the drift information 280 on the basis of the Doppler frequency information 272a and the transmission/reception frequency difference information 278. Consequently, it is possible to provide a positioning system 10 that can acquire information indicating drift even if the positioning system is a server positioning type positioning system.

The terminal 50 can acquire as many SPS satellites 12a-12d as necessary for positioning calculations by the positioning server 70 on the basis of the transmission frequency information 252, the Doppler frequency information 272a, and the drift information 280.

Consequently, after generating the drift information 280, it is possible to receive as many signals S1-S4 from the SPS satellites 12a-12d as necessary for positioning calculations by the positioning server 70. Moreover, as described above, the terminal 50 stores the drift information 280 in the terminal third storing unit 270. The terminal 50 uses the drift information 280 in order to receive the signals S1-S4 (see FIG. 1) that are used when positioning positional information for the next time period is acquired from the positioning server 70 (see FIG. 1).

### An Example of an Operation of the Positioning System 10 According to this Embodiment

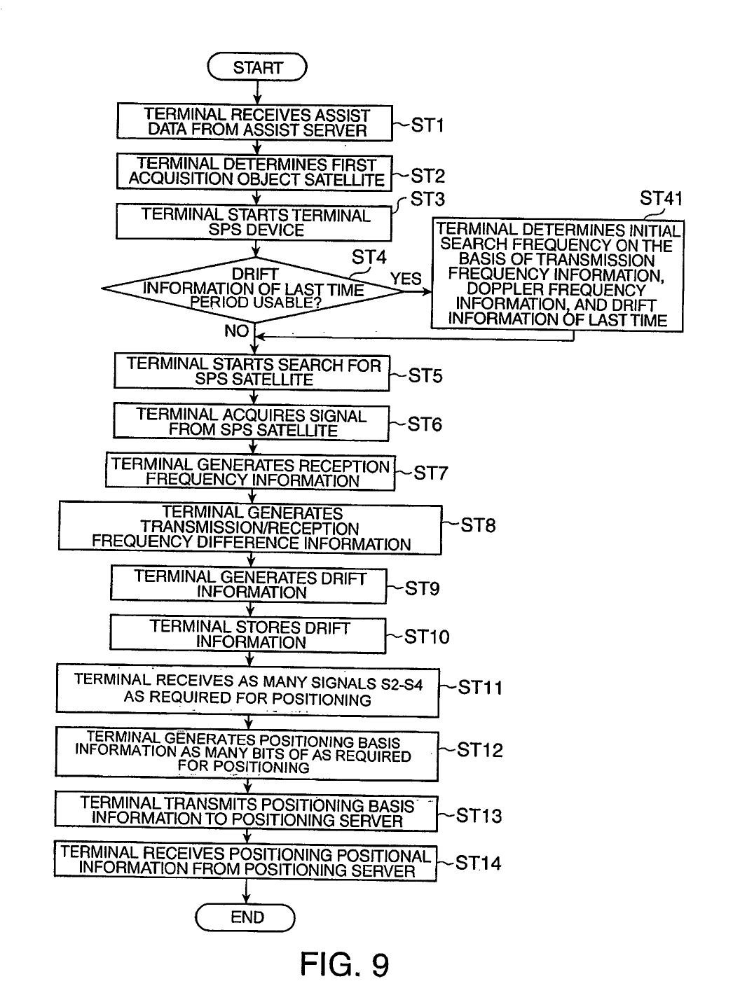

The positioning system 10 is constituted as described above. An example of an operation of the positioning system 10 will be explained. FIG. 9 is a schematic flowchart showing an example of an operation of the positioning system 10.

First, the terminal 50 receives the assist data 156 (see FIG. 4) from the assist server 20 (step ST1). This step ST1 is an example of the supplementary information acquiring step. The terminal 50 stores the received assist data 156 in the terminal third storing unit 270 as assist data 272.

Subsequently, the terminal 50 determines the SPS satellite 12a (see FIG. 1) as a first acquisition object satellite (step ST2) and starts the terminal SPS device 62 (see FIG. 3) (step ST3).

Subsequently, the terminal 50 judges whether the drift information 280 (see FIG. 5) from the last time period is usable (step ST4). If it is judged that the drift information 280 of the last time period is not usable, the terminal 50 starts a search for the SPS satellite 12a on the basis of the transmission frequency information 252 of the SPS satellite 12a and the Doppler frequency information 272a corresponding to for example, the SPS satellite 12a (step ST5) and receives the signal S1 from the SPS satellite 12a (step ST6). This step ST6 is an example of the signal receiving step.

Subsequently, the terminal 50 generates the reception frequency information 276 (see FIG. 5) indicating a frequency at the time when the signal S1 is received (step ST7). This step ST7 is an example of the reception frequency information generating step.

Subsequently, the terminal 50 generates the transmission/reception frequency difference information 278 (see FIG. 7A) indicating a frequency difference between a transmission frequency of the signal S1 and the reception frequency of the signal S1 (step ST8). This step ST8 is an example of the frequency difference information generating step.

Subsequently, the terminal 50 generates the drift information 280 (see FIG. 7B) on the basis of the Doppler frequency information 272a of the signal S1 and the transmission/reception frequency difference information 278 generated in step ST8 (step ST9). This step ST9 is an example of the drift frequency information generating step.

Subsequently, the terminal 50 stores the drift information 280 generated in step ST9 in the terminal third storing unit 270 (step ST10).

Subsequently, the terminal 50 receives as many additionally signals S2-S4 from the SPS satellites 12b-12d as necessary for positioning calculations from the positioning server 70 (see FIG. 1) (step ST11). In this case, the terminal 50 receives the signals S2-S4 on the basis of the transmission frequency information 252 indicating a transmission frequency at which the respective SPS satellites 12b-12d transmit the signals S2-S4, the Doppler frequency information 272a corresponding to the respective SPS satellite 12b-12d, and the drift information 280 stored in step ST10. In this way, by adding an influence of the drift information 280, it is possible to receive promptly the signals S2-S4 from the SPS satellites 12b-12d. This step ST11 is an example of the positioning-requiring-number-of-position-related-signals receiving step.

Subsequently, the terminal 50 generates as many bits of positioning basis information 282 (see FIG. 8) as required for positioning in response to the signals S1-S4 received in step ST11 (step ST12). This step ST12 is an example of the positioning basis information generating step.

Subsequently, the terminal 50 transmits the positioning basis information 282 generated in step ST12 to the positioning server 70 (see FIG. 1) (step ST13). This step ST13 is an example of the positioning basis information transmitting step.

Subsequently, the terminal 50 receives positioning positional information generated by the positioning server 70 (step ST14). As explained above, the terminal 50 can generate the drift information 280 even if the positioning system is a server measurement type positioning system 10.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

### Second Embodiment

A second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. Differences will be hereinafter mainly explained.

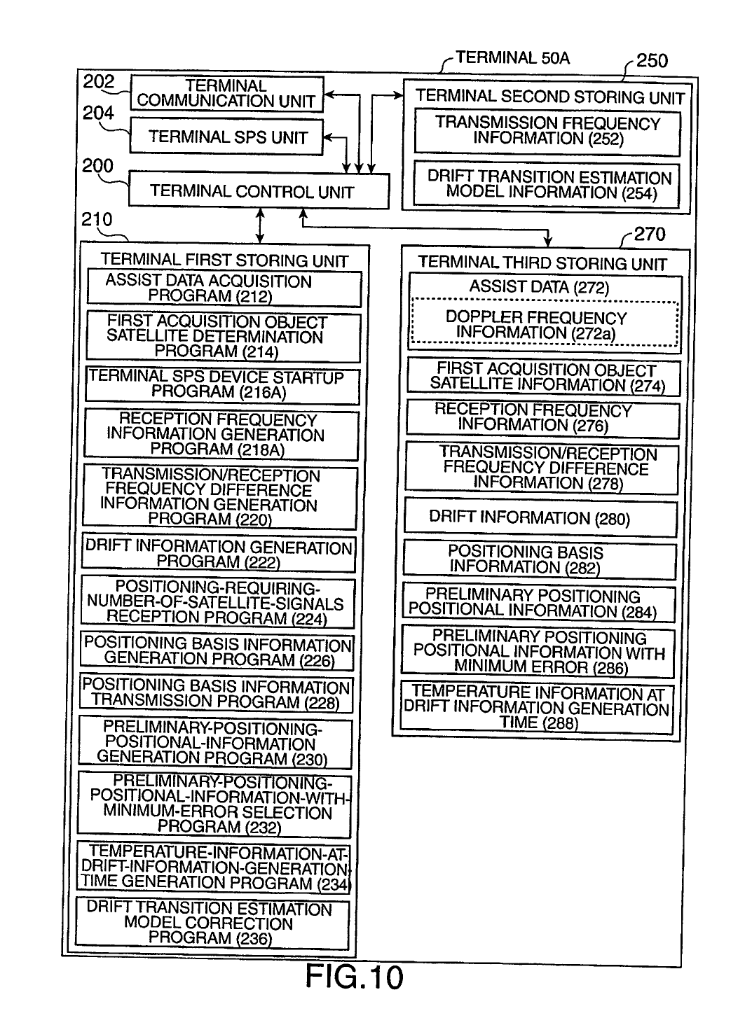

FIG. 10 is a view of a schematic diagram showing a main software configuration of a terminal 50A (see FIG. 1) according to the second embodiment. As shown in FIG. 10, in the second embodiment, unlike the first embodiment, on the basis of a terminal SPS device startup program 216A stored in the terminal first storing unit 210, the terminal 50A acquires, for example, the SPS satellite 12a, which is a first acquisition object satellite. At the same time or after the SPS satellite 12a is acquired and before the drift information 280 is generated, the terminal 50A receives the signals S2-S4 from the SPS satellites 12b-12d. The terminal 50A receives as many signals S1-S4 as necessary for preliminary positioning calculations described later, for example, the four or more signals S1-S4.

As shown in FIG. 10, the terminal 50A stores a preliminary-positioning-positional-information generation program 230 in the terminal first storing unit 210. The preliminary-positioning-positional-information generation program 230 has information that allows the terminal control unit 200 to perform preliminary positioning calculations and generates preliminary positioning positional information 284 indicating a preliminary positioning position of the terminal 50 on the basis of the received plurality of signals S1-S4. In other words, the preliminary-positioning-positional-information generating program 230 and the terminal control unit 200 are examples of the preliminary-positioning-positional-information generating unit.

Unlike the positioning positional information generated by the positioning server 70 (see FIG. 1), the preliminary positioning positional information 284 has positioning calculations of a preliminary nature that are carried out inside the terminal 50A. Whereas, the positioning positional information generated by the positioning server 70 may be generated by, for example, a complicated arithmetic operation such as map matching, the preliminary positioning positional information 284 only has to attain an object of excluding error signals such as signals unrelated to an SPS and reflected waves. Thus, the preliminary positioning positional information 284 has provisional positioning calculations based on limited information held by the terminal 50A. Therefore, the terminal 50A can more promptly generate the preliminary positioning positional information 284 compared with the case in which a complicated arithmetic operation is performed.

The terminal control unit 50A stores the generated preliminary positioning positional information 284 in the terminal third storing unit 270.

As shown in FIG. 10, the terminal 50A stores a preliminary-positioning-positional-information-with-minimum-error selection program 232 in the terminal first storing unit 210. The preliminary-positioning-positional-information-with-minimum-error selection program 232 has information that allows the terminal control unit 200 to select a preliminary positioning positional information with minimum error 286 having a minimum positioning error from the plurality of pieces of preliminary positioning positional information 284. In other words, the preliminary-positioning-positional-information-with-minimum-error selection program 232 and the terminal control unit 200 are examples of the preliminary-positioning-positional-information-with-minimum-error selecting unit.

For example, the terminal control unit 200 selects the preliminary positioning positional information 284, which indicates a position closest to a positioning positional information acquired from the positioning server 70 (see FIG. 1) during the last time period, as the preliminary positioning positional information with minimum error 286. The terminal control unit 200 selects the preliminary positioning positional information 284 on the basis of the preliminary-positioning-positional-information-with-minimum-error selection program 232 and stores the preliminary positioning positional information 284 in the terminal third storing unit 270.

The terminal control unit 200 generates the reception frequency information 276, which indicates a frequency at which the signals S1-S4 corresponding to the preliminary positioning positional information with minimum error 286, on the basis of a reception frequency information generation program 218A stored in the terminal first storing unit 210. The signals S1-S4 corresponding to the preliminary positioning positional information with minimum error 286 are the basis for calculating the most appropriate preliminary positioning position. Thus, the signals S1-S4 are not considered to be error signals. Therefore, it is possible to generate the reception frequency information 276 with higher reliability by using the frequency at which the signals S1-S4 corresponding to the preliminary positioning positional information with minimum error 286 are received.

The transmission/reception frequency information 278 and the drift information 280, which are generated on the basis of the reception frequency information 276 with higher reliability, also have higher reliability. As shown in FIG. 10, the terminal 50A stores drift transition estimation model information 254 in the terminal second storing unit 250.

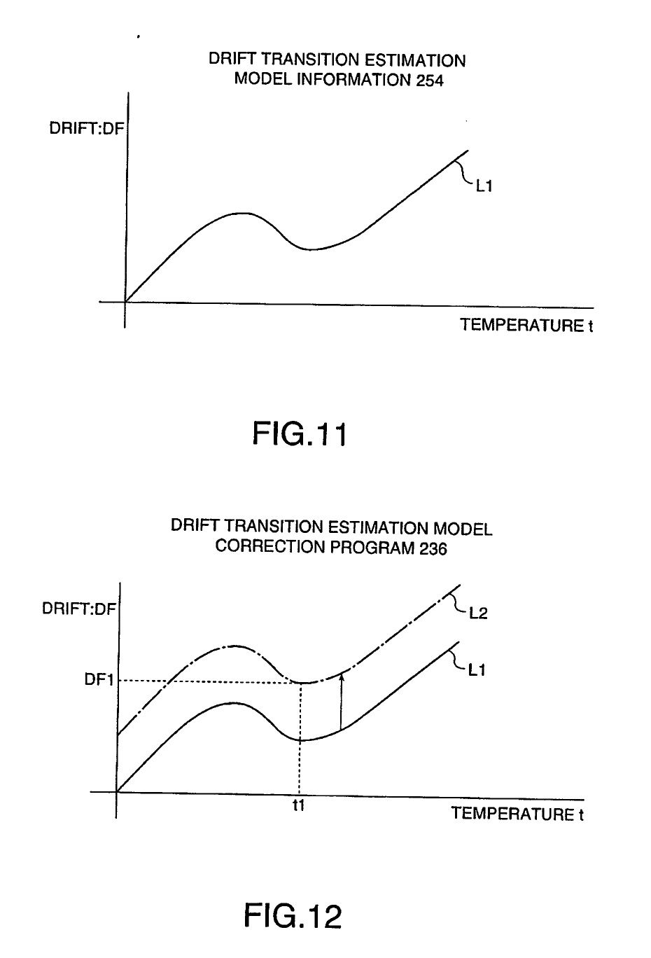

FIG. 11 is a view of a graph showing an example of the drift transition estimation model information 254. As shown in FIG. 11, the drift transition estimation model information 254 has information indicating transition due to a change in temperature t of the drift DF. The drift transition estimation model information 254 is an example of drift frequency transition information, and the terminal second storing unit 250 is an example of the drift-frequency-transition-information storing unit.

The terminal 50A can promptly receive the signals S1-S4 by using the drift transition estimation model information 254. However, the characteristics of the quartz oscillator 62a (see FIG. 3) change with time and the drift transition estimation model information 254 stored in the terminal 50A diverges from an actual state in some cases. In this respect, the terminal 50A can correct the drift transition estimation model information 254 with the constitution described below.

As shown in FIG. 10, the terminal 50A stores a temperature-information-at-drift-information-generation-time generation program 234 in the terminal first storing unit 210. The temperature-information-at-drift-information-generation-time generation program 234 has information that allows the terminal control unit 200 to generate temperature information at drift information generation time 288 indicating temperature at the time when the drift information 280 is generated. The temperature-information-at-drift-information-generation-time generation program 234 and the terminal control unit 200 are examples of the temperature-information-at-drift-information-generation-time generating unit.

As shown in FIG. 10, the terminal 50A stores a drift transition estimation model correction program 236 in the terminal first storing unit 250. The drift transition estimation model correction program 236 has information that allows the terminal control unit 200 to correct the drift transition estimation model information 254 on the basis of the drift information 280 and the temperature information at drift information generation time 288.

FIG. 12 is a view of a graph showing an example of the drift transition estimation model correction program 236. As shown in FIG. 12, the drift transition estimation model correction program 236 is set so that, for example, a curve L1 indicating an initial drift transition estimation model is translated on the basis of the drift DF1 indicated by the drift information 280 and temperature t1 indicated by the temperature information at drift information generation time 288 to be corrected to a curve L2.

As explained above, the terminal 50A can correct the drift transition estimation model information 254 and can receive the signals S1-S4 by using the drift transition estimation model information 254 after the correction.

### Example of an Operation of the Positioning System 10A According to the Second Embodiment

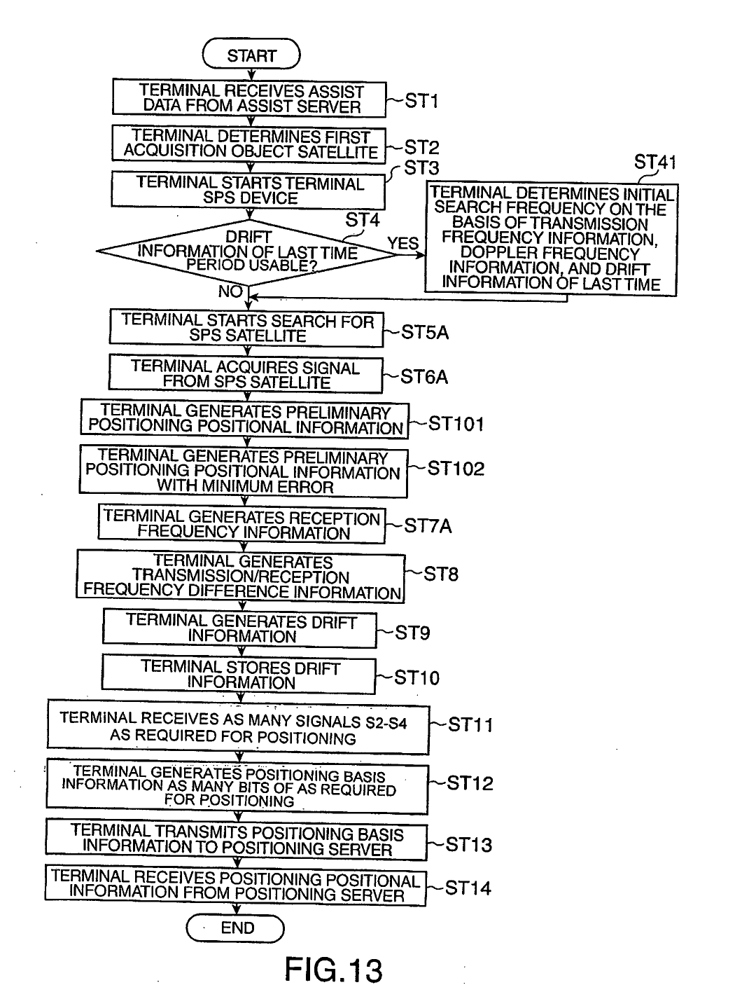

The positioning system 10A is constituted as described above. An example of an operation of the positioning system 10A will be explained. FIG. 13 is a view of a schematic flowchart showing an example of an operation of the positioning system 10A.

Following step ST4 or step 41, for example, after acquiring the SPS satellite 12a that is the first acquisition object satellite and before generating the drift information 280, the terminal 50A searches for the signals S2-S4 from the SPS satellites 12b-12d (step ST5A) and receives a plurality of signals including the signal S1 (step ST6A).

Subsequently, the terminal 50A performs preliminary positioning calculations and generates the preliminary positioning positional information 284 indicating a preliminary positioning position of the terminal 50A on the basis of the plurality of signals S1, etc (step ST101).

Subsequently, the terminal 50A selects the preliminary positioning positional information with minimum error 286 (see FIG. 10) from the plurality of bits of preliminary positioning positional information 284 generated in step ST101 (step ST102). Consequently, if the preliminary positioning positional information 284, which is generated on the basis of an error signal, has a large error, the preliminary positioning positional information 284 is excluded.

Subsequently, the terminal 50A generates the reception frequency information 276 indicating a frequency at which the signals S1 and so forth corresponding to the preliminary positioning positional information with minimum error 286 are received (step ST7A). In this way, the terminal 50A can exclude an error signal or the like as a prerequisite for generating the drift information 280, the terminal 50A can generate the accurate drift information 280.

A Program, a Computer Readable Recording Medium, and So Forth

It is possible to realize a control program for a terminal apparatus to cause a computer to execute a supplementary information acquiring step, a signal receiving step, a reception frequency information generating step, a frequency difference information generating step, a drift frequency information generating step, a positioning-requiring-number-of-position-related-signals receiving step, a positioning basis information generating step, a positioning basis information transmitting step, and the like in the examples of the operations. It is also possible to realize a computer readable recording medium having recorded therein such a control program for a terminal apparatus. It is possible to realize a program storage medium, which is used to install the control program for a terminal apparatus or the like in a computer and bringing the control program or the like into a state the control program or the like is executable by the computer, not only with a flexible disk such as floppy disk and a package medium such as a Compact Disc Read Only Memory (CD-ROM), a compact Disc-Recordable (CD-R), a Compact Disc-Rewritable (CD-RW), or a Digital Versatile Disc (DVD) but also with a semiconductor memory, a magnetic disk, a magneto-optical disk, or the like in which a program is stored temporarily or permanently.

The invention is not limited to the embodiments described above. The embodiments may be combined with one another.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A positioning system comprising:
a terminal apparatus being configured to acquire positioning positional information from a positioning apparatus performing positioning calculations based on position related signals from a plurality of positional information satellites; and
a supplementary information providing apparatus being configured to communicate with said terminal apparatus and to provide said terminal apparatus with supplementary information to receive position related signals, said supplementary information including Doppler frequency information indicating a Doppler frequency being a change in a frequency of the position related signals due to relative movement of said positional information satellites and said terminal apparatus, said terminal apparatus including,
a supplementary information acquiring unit being configured to acquire
said supplementary information from said supplementary information providing apparatus,
a signal receiving unit being configured to receive said position related signals from said positional information satellites on the basis of said supplementary information,
a reception frequency information generating unit being configured to generate reception frequency information indicating a reception frequency when said position related signals are received,
a frequency difference information generating unit being configured to generate frequency difference information indicating a frequency difference between a transmission frequency being a frequency when said positional information satellites transmit said position related signals, and said reception frequency,
a drift frequency information generating unit being configured to generate drift frequency information indicating a drift frequency being shift of said reception frequency due to a factor inside said terminal apparatus on the basis of said Doppler frequency information included in said supplementary information and said frequency difference information generated by said terminal apparatus,
a positioning-requiring-number-of-position-related-signals receiving unit being configured to receive as many of said position related signals as required for positioning calculations by said positioning apparatus on the basis of said transmission frequency information indicating said transmission frequency of said position related signals from said positional information satellites, said Doppler frequency information corresponding to said positional information satellites, and said drift frequency information,
a positioning basis information generating unit being configured to generate positioning basis information to be used by said positioning apparatus for positioning calculations on the basis of said received respective position related signals, and
a positioning basis information transmitting unit being configured to transmit said positioning basis information to said positioning apparatus.

2. The positioning system according to claim 1, wherein said terminal apparatus is configured to communicate with said positioning apparatus via a communication base station and a network.

3. The positioning system according to claim 2, wherein said network is the Internet.

4. The positioning system according to claim 1, wherein said terminal apparatus is a cellular phone, a personal handy-phone system, or a personal digital assistant.

5. The positioning system according to claim 1, wherein said supplementary information providing apparatus includes,
a bus,
storage connected to said bus,
a CPU configured to perform processing of a predetermined program and to control said storage, said CPU is connected to said bus,
external storage connected to said bus,
an input device connected to said bus and configured to input information,
a server communication device configured to communicate with said terminal apparatus,
a server SPS device configured to receive signals from said positional information satellites, and
a server display device configured to display information.

6. The positioning system according to claim 5, wherein said terminal apparatus includes,
a bus,
storage connected to said bus,
a CPU configured to perform processing of a predetermined program and to control said storage, said CPU is connected to said bus,
an input device connected to said bus and configured to input information,
a terminal communication device configured to communicate with said terminal apparatus,
a terminal SPS device configured to receive signals from said positional information satellites, and
a terminal display device configured to display information.

7. The positioning system according to claim 6, wherein said terminal SPS device has a quartz oscillator that generates a signal forming a basis of a synchronizing signal that is necessary for said terminal SPS device to acquire signals from said positional information satellites.

8. A terminal apparatus being configured to acquire positioning positional information from a positioning apparatus that performs positioning calculation based on position related signals from a plurality of positional information satellites, the terminal apparatus comprising:
a supplementary information acquiring unit being configured to acquire supplementary information having Doppler frequency information indicating a Doppler frequency being a change in a frequency of the position related signals due to relative movement of the respective positional information satellites and the terminal apparatus from a supplementary information providing apparatus being configured to communicate with the terminal apparatus;
a signal receiving unit being configured to receive the position related signals from the positional information satellites on the basis of the supplementary information;
a reception frequency information generating unit being configured to generate reception frequency information indicating a reception frequency when the position related signals are received;
a frequency difference information generating unit being configured to generate frequency difference information indicating a frequency difference between a transmission frequency being a frequency when the respective positional information satellites transmit the position related signals, and the reception frequency;
a drift frequency information generating unit being configured to generate drift frequency information indicating a drift frequency being a shift of the reception frequency due to a factor inside the terminal apparatus on the basis of the Doppler frequency information included in the supplementary information and the frequency difference information generated by the terminal apparatus;
a positioning-requiring-number-of-position-related-signals receiving unit being configured to receive as many position related signals as required for positioning calculation by the positioning apparatus on the basis of the transmission frequency information indicating the transmission frequency of the position related signals from the respective positional information satellites, the Doppler frequency information corresponding to the respective positional information satellites, and the drift frequency information;
a positioning basis information generating unit being configured to generate positioning basis information to be used by the positioning apparatus for the positioning calculation on the basis of the received respective position related signals; and
a positioning basis information transmitting unit being configured to transmit the positioning basis information to the positioning apparatus.

9. A terminal apparatus according to claim 8, wherein the drift frequency information generating unit generates the drift frequency information on the basis of at least one set of the Doppler frequency information and the frequency difference information.

10. A terminal apparatus according to claim 9, further comprising,
a preliminary-positioning-positional-information generating unit that performs preliminary positioning calculation on the basis of a plurality of position related signals received by the signal receiving unit to generate preliminary positioning positional information indicating a preliminary positioning position, and
a preliminary-positioning-positional-information-with-minimum-error selecting unit that selects preliminary positioning positional information with minimum error that is the preliminary positioning positional information with a minimum positioning error from a plurality of pieces of the preliminary positioning positional information generated by the preliminary-positioning-positional-information generating unit, wherein
the reception frequency information generating unit generates the reception frequency information indicating a frequency at which the position related signals corresponding to the preliminary positioning positional information with minimum error are received.

11. A terminal apparatus according to claim 8, further comprising,
a preliminary-positioning-positional-information generating unit that performs preliminary positioning calculation on the basis of a plurality of position related signals received by the signal receiving unit to generate preliminary positioning positional information indicating a preliminary positioning position, and
a preliminary-positioning-positional-information-with-minimum-error selecting unit that selects preliminary positioning positional information with minimum error that is the preliminary positioning positional information with a minimum positioning error from a plurality of pieces of the preliminary positioning positional information generated by the preliminary-positioning-positional-information generating unit, wherein
the reception frequency information generating unit generates the reception frequency information indicating a frequency at which the position related signals corresponding to the preliminary positioning positional information with minimum error are received.

12. A terminal apparatus according to claim 8, further comprising a drift information storing unit that stores the drift frequency information, wherein
the signal receiving unit uses the drift frequency information to receive the position related information to acquire the positioning positional information from the positioning apparatus for the following time period.

13. A terminal apparatus according to claim 8, further comprising,
a drift-frequency-transition-information storing unit that stores drift frequency transition information indicating transition of the drift frequency due to temperature change,
a temperature-information-at-drift-information-generation-time generating unit that generates temperature information at the time of drift information generation indicating temperature at the time when the drift frequency information is generated, and
a drift-frequency-transition-information correcting unit that corrects the drift frequency transition information on the basis of the drift frequency information and the temperature information at the time of drift information generation.

14. A control program for a terminal apparatus adapted to run on a computer, comprising:
computer code for acquiring positioning positional information from a positioning apparatus performing positioning calculation based on position related signals from a plurality of positional information satellites by a terminal apparatus, acquiring supplementary information including Doppler frequency information indicating a Doppler frequency being a change in a frequency of the position related signals due to relative movement of the respective positional information satellites and said terminal apparatus by said terminal apparatus from a supplementary information providing apparatus being configured to communicate with said terminal apparatus;
computer code for receiving said position related signals from said positional information satellites on the basis of said supplementary information by said terminal apparatus;
computer code for generating reception frequency information indicating a reception frequency when said position related signals are received by said terminal apparatus;
computer code for generating by said terminal apparatus generates frequency difference information indicating a frequency difference between transmission frequency and said reception frequency;
computer code for generating by said terminal apparatus drift frequency information indicating a drift frequency being a shift of said reception frequency due to a factor inside said terminal apparatus on the basis of said Doppler frequency information included in said supplementary information and said frequency difference information generated by said terminal apparatus;
computer code for receiving by said terminal apparatus as many of said position related signals as required for positioning calculation by said positioning apparatus on the basis of said transmission frequency information indicating transmission frequency of said position related signals from said positional information satellites, the Doppler frequency information corresponding to said information satellites, and the drift frequency information;
computer code for generating by said terminal apparatus positioning basis information to be used by said positioning apparatus for said positioning calculation on the basis of said position related signals having been received; and
computer code for transmitting by said terminal apparatus said positioning basis information to said positioning apparatus.

15. A computer recording medium having recorded therein a control program for a terminal apparatus according to claim 14.
